(19) United States
(12) Patent Application Publication
(10) Pub. No.: US 2020/0291630 A1
(43) Pub. Date: Sep. 17, 2020

(54) STORMWATER CHANNEL AND METHOD FOR IMPROVING A STORMWATER CHANNEL ECOSYSTEM

(71) Applicant: Stanley James Raddon, Arcadia, CA (US)

(72) Inventor: Stanley James Raddon, Arcadia, CA (US)

(21) Appl. No.: 16/818,908

(22) Filed: Mar. 13, 2020

Related U.S. Application Data
(60) Provisional application No. 62/919,411, filed on Mar. 13, 2019.

(51) Int. Cl. E03F 1/00; A01G 27/02; E02B 8/08; A01G 9/02

(52) U.S. Cl. CPC E03F 1/00; A01G 9/02; E02B 8/085; A01G 27/02

(57) ABSTRACT

A stormwater channel includes a central channel bed flanked by left and right walls, with riparian planters and riparian reservoirs extending longitudinally through the channel. Water flows through the planters and reservoirs. Each planter contains plant-anchoring material and biochar. Riparian plant seeds or seedlings are planted in the planters and watered to form a riparian ecosystem. The stormwater channel also includes a fish migration channel adjacent to the riparian planters and reservoirs, enabling anadromous fish to swim upstream through the channel. Fish can be detected, trapped, and relocated past barriers using a drone.

### CROSS REFERENCE TO RELATED APPLICATION

This application claims the benefit of U.S. provisional application No. 62/919,411, filed Mar. 13, 2019, the entire content of which is incorporated herein by this reference.

### FIELD OF THE INVENTION

The invention relates to stormwater channels and methods for improving the ecosystems of stormwater channels and restoring riparian habitat in urban, suburban, and surrounding locales.

### BACKGROUND OF THE INVENTION

Large cities and their suburbs are typically so built up and covered in asphalt and concrete that only a small fraction of incident rainwater is absorbed into the ground. Stormwater and flood control systems are typically lined with concrete and designed to move water away from the area, toward the sea, rather than to capture the water for future use. In Los Angeles County, for example, the average annual rainfall from 1877 through 2018 was roughly 56 billion gallons, yet most of that water flowed across the basin into the Pacific Ocean in mere hours, leaving little positive benefit to people and nature. Where stormwater holding basins are employed, they generally suffer from a number of problems: they tend to be shallow and prone to substantial loss of water by evaporation; they are susceptible to wind-borne pollution and algae blooms; they foster mosquito breeding; and they tend to flood.

To make matters worse, natural waterways that pass through metropolitan areas have been encased in concrete and “tamed,” at great cost to riparian ecosystems and flora and fauna in and near the area. A need exists for improved stormwater channels that allow more water to be captured for future use and that foster riparian restoration, including the reestablishment of native plants and the migration of anadromous fish to their spawning grounds.

### SUMMARY OF THE INVENTION

In one aspect of the invention, an improved stormwater channel includes a central channel bed flanked by left and right walls or banks, with a number of riparian planters and riparian reservoirs extending longitudinally along some of, or the entire, channel. The planters and reservoirs are in fluid communication with each other and allow water to flow through them, from upstream to downstream. Each planter is loaded with riparian plant-anchoring material, such as a mixture of gravel, sand, and rocks. Preferably, a soil amendment, such as biochar, is also included. Riparian plant seedlings and/or seeds are planted in the planters and watered—by rain, snowmelt, and/or stormwater runoff to form a riparian ecosystem in the stormwater channel. In addition, the modified stormwater channel includes a fish migration channel adjacent to the riparian planters and reservoirs, enabling anadromous fish to swim upstream through the stormwater channel.

In another aspect of the invention, a method for trapping fish that migrate through the channel is provided and includes sensing the fish as they near a dam or other barrier in the channel; trapping the fish; and moving the fish by drone over the barrier to a location further upstream.

### BRIEF DESCRIPTION OF THE DRAWINGS

Various features and advantages of the invention will be understood more fully when considered in conjunction with the appended drawings (which are not necessarily drawn to scale), wherein:

FIG. 1 is a schematic plan view of a stormwater channel according to one embodiment of the invention;

FIG. 2 is a sectional view of the embodiment shown in FIG. 1, taken along line A-A′;

FIG. 3 is a schematic plan view of a stormwater channel according to another embodiment of the invention;

FIG. 4 is a sectional view of the embodiment shown in FIG. 3, taken along line B-B′;

FIG. 5 is a schematic sectional view of a stormwater channel according to another embodiment of the invention;

FIG. 6 is a schematic plan view of a stormwater channel according to another embodiment of the invention;

FIG. 7 is a schematic sectional side view of a riparian planter adjacent to a reservoir according to one embodiment of the invention; and

FIG. 8 is a schematic illustration of a method for collecting and transporting migrating fish over a barrier in a waterway.

### DETAILED DESCRIPTION

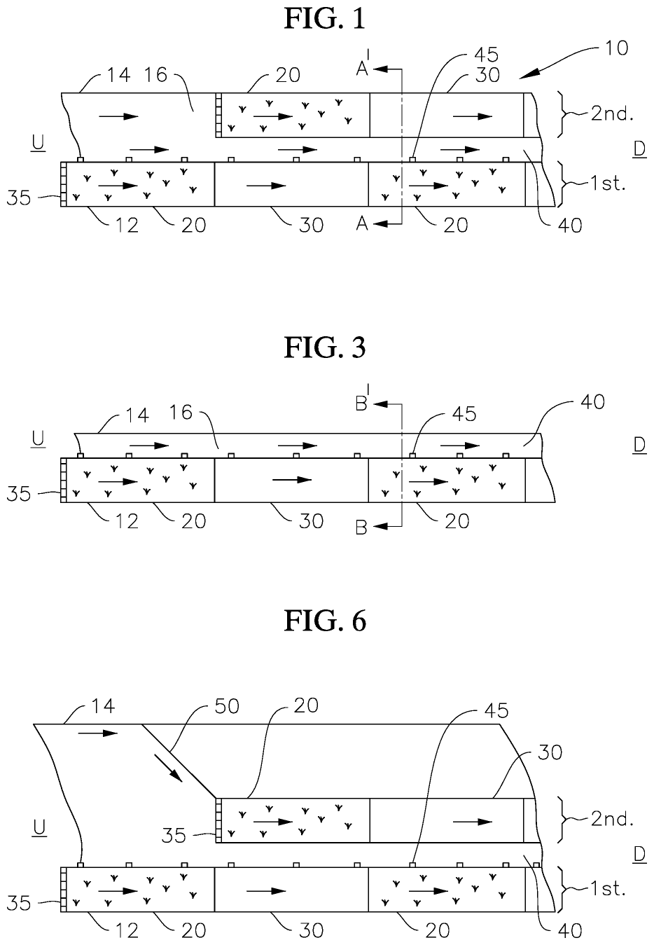

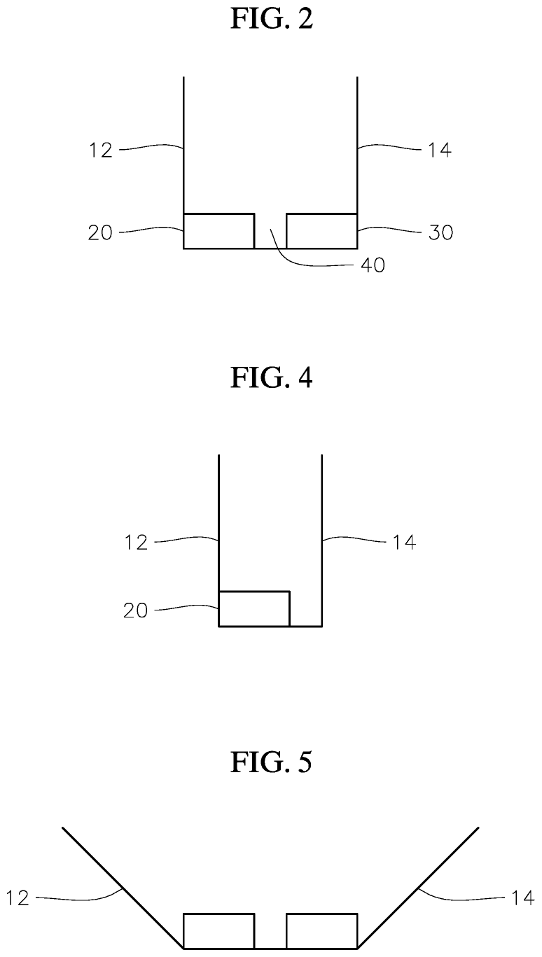

An embodiment of an improved stormwater channel is shown in FIGS. 1 and 2. The stormwater channel 10 has an upstream direction “U” and a downstream direction “D” and includes a left wall 12 and a right wall 14, which flank a central bed 16. (The “left” and “right” orientations are from the perspective of standing on the channel bed, looking upstream.) The upper surface of the bed is either lined (e.g., with concrete) or unlined. Two rows of multiple riparian planters 20 and adjacent reservoirs 30 extend longitudinally down the channel. Each planter and reservoir is quite long, e.g., from about 300 feet to 1400 feet in length. Water is free to travel down the storm water channel between the left and right walls and through the planters and reservoirs, in the direction denoted by the arrows in FIG. 1. A grate 35 is located at the upstream end of the two lead planters 20 (the planters farthest to the left in FIG. 1). Riparian plants grow in, and extend upwardly outward from, the planters.

In this embodiment, a first row of alternating planters and reservoirs is located adjacent to the left wall 12 of the channel, while a second row of planters and reservoirs is located adjacent to the right wall 14 of the channel. A fish channel 40 is located between the two rows of planters and reservoirs and provides a path for anadromous fish to swim through as they move up the stormwater channel. Optionally, small (˜7″ wide) fish rest blocks 45 are secured to the planters and/or the reservoirs, intermittently throughout the fish channel, e.g., ˜every 100′ or so, and provide a respite from the full force of water flowing through the fish channel.

Referring now to FIGS. 3 and 4, a different embodiment of an improved stormwater channel is shown. The stormwater channel 10 is similar to the channel depicted in FIGS. 1 and 2, but only a single row of alternating planters 20 and reservoirs 30 is present. A fish channel 40 is located between the planters and reservoirs on the left and the right wall 14 of the stormwater channel 10.

In the stormwater channels depicted in FIGS. 1-4, the channel walls are vertical, and the walls are substantially higher than the height of the riparian planters and reservoirs. Some stormwater channels are 6′, 8′, 10′ high, or even higher. In contrast, the riparian planters and reservoirs described herein are significantly lower, e.g., 12″-14″ high. As a result, the planters and reservoirs do not significantly diminish the capacity of the stormwater channel, which can be important during high water events like 100 year and 500 year floods, or worse.

In an alternate embodiment shown in FIG. 5, the walls are banked, yet still are significantly higher than the planters and reservoirs.

Referring to FIG. 6, an alternate embodiment of an improved stormwater channel is shown, with left and right walls 12, 14 separated by a much wider channel bed 16. Two rows of riparian planters 20 and adjacent reservoirs 30 extend longitudinally down the channel 10. A first row of alternating planters and reservoirs is located adjacent to the left wall 12 of the channel, while a second alternating row of planters and reservoirs is spaced apart from, and parallel to, the first row. The gap between the two rows defines a fish channel 40. In this embodiment, there is a wide expanse of stormwater channel bed between the second row of planters/reservoirs (on the right) and the right channel wall 14.

A low wall 50, referred to as a “conservation wall,” extends diagonally from an upstream region of the stormwater channel on the right to the second row of planters and reservoirs. The conservation wall 50 is approximately 12-14″ high, roughly the same height as the riparian planters and reservoirs. In heavy rains, with several feet of water coursing down the stormwater channel 10, water extends laterally across the entire width of the channel 10. Some of it passes over the conservation wall 50 and travels through the channel downstream. Some of the water passes through the planters and reservoirs, and some of the water submerges the planters and passes over them. Advantageously, even when far less water is present, the conservation wall ensures that some water is diverted to the left so that it passes through the planters, reservoirs, and fish channel.

In one embodiment, a riparian planter resembles a long box, with a top, bottom, two sides, and two ends. The top is open initially—to allow it to be filled, as described herein—and then covered with grating, which can be fixed in place or removable. In one embodiment, the grating fits into a recessed portion of an upper surface of the reservoir. In another embodiment, the grating is attached by hinges. In another embodiment, the grating is bolted into place. Planters and reservoirs are conveniently formed by setting up wooden forms in the stormwater channels (e.g., during the dry season), pouring concrete into the forms, and allowing the concrete to set. Optionally, bolts and bolt hangars can be used to secure the planters and reservoirs even more securely. Although the planters depicted in the drawings are straight (rectangular), it is also possible to form curved planters and reservoirs, which can be useful where there are curved stretches of stormwater channel. The planters and reservoirs may be curved to match the curved contours of the channel.

The ends of the planters and reservoirs are at least partially open to the flow of water. Thus, in one embodiment, the ends have a closed appearance, yet with perforations to enable water to flow through them. In another embodiment, the ends are more open, but capped with a grate, filter, permeable membrane, or similar article. When a reservoir is placed adjacent a planter, water can pass through the planter into the reservoir. In one embodiment, the downstream end of a planter is partially or fully separated from the upstream end of a reservoir by a screen, filter, water permeable membrane, or similar article, to reduce or retard the flow of solid material out of the planter into the reservoir.

Each planter is filled with riparian plant-anchoring material, and riparian plant seedlings or seeds are then planted in the planters. Nonlimiting examples of plant-anchoring materials include river rock, gravel, gravel, sand, and mixtures thereof. In addition, in one embodiment it is advantageous to include biochar, which can remove pollutants from the water and acts as a plant “soil” amendment. It is preferred to introduce only riparian plants (and/or their seeds) that are native to the area in which the stormwater channel is located. This helps to establish a natural ecosystem that attracts pollinators, other insects, invertebrates, amphibians, reptiles, birds, and even mammals that are, or once were, native to the area in which the stormwater channel is located. Lists and descriptions of riparian plants native to most watersheds are available on various internet websites, for example, https://www.cramwetlands.org, www.rmc.ca.gov, and the California Native Plant Society's online database.

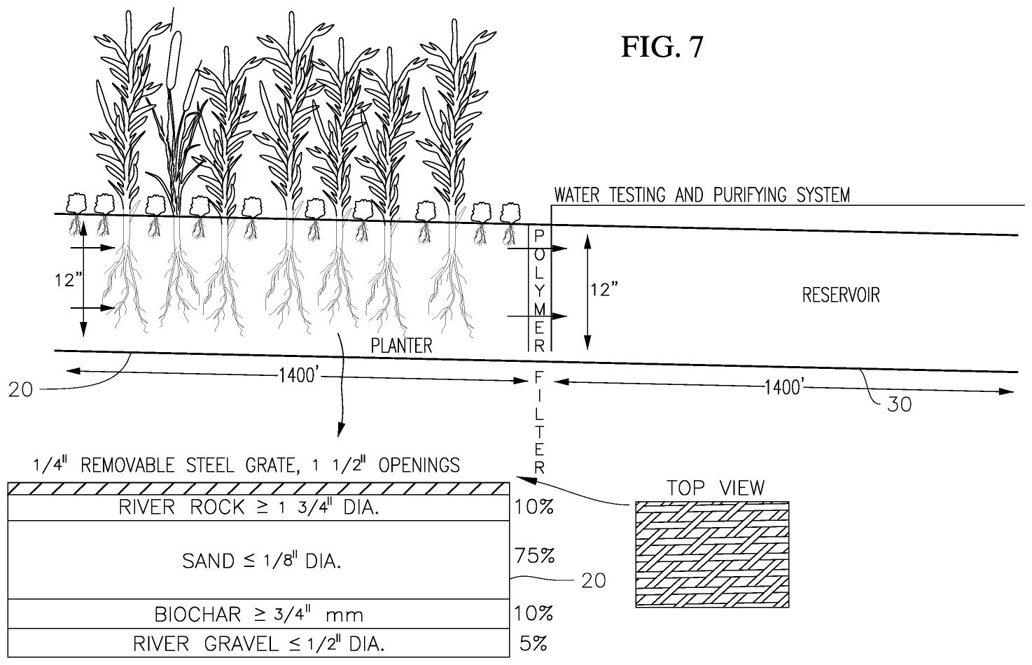

A schematic illustration of a planter loaded with various materials, and the junction between planter and reservoir, is provided in FIG. 7. Optionally, a water testing and/or water purifying system is introduced into the reservoir at this location. FIG. 7 also illustrates a characteristic of a typical stormwater channel: it is sloped; in this case, there is a 4% grade extending down the channel. This grade is also present in the path through the planter and reservoir. Of course, in other stormwater channels, the grade may be higher or lower.

In one embodiment of the invention, a pumping system is employed to remove water from the reservoirs, particularly after a heavy rain or similar event. The pumping system includes one or more pumps, pipes, water level sensors, a power supply, and a controller (e.g., a microprocessor or similar control unit). Thus, a pump (or a pipe or hose connected to a pump) extends into the downstream end of each reservoir. The pump(s) are activated, and water is pumped out of the reservoirs to a desired location, such as a nearby municipal water treatment plant. In one embodiment, the pumps are solar powered, and the pumping system includes components for powering each pump or multiple pumps, e.g., photovoltaic modules, controllers, inverters, charge regulators, storage batteries, etc.

The modified stormwater channel described herein offer a number of benefits. First, the riparian plants and the biochar should promote phytoremediation of the water by degrading, sequestering, and/or removing pollutants and toxins from the water. Second, the system facilitates the collection of water (rainfall, stormwater runoff, snow melt, etc.) within the many reservoirs, making it available for reuse. Third, the fish rest blocks, conservation wall, and dedicated fish channel will aid anadromous fish in their upstream migration through the stormwater channel.

In another aspect of the invention, a method of modifying an existing stormwater channel to foster riparian plant growth, collect water for reuse, and facilitate upstream migration of anadromous fish is provided. One or more rows of planters and alternating reservoirs is formed in and secured to the floor of the channel (channel bed). Each planter is filled with riparian plant-anchoring material, and optionally biochar or a similar amendment, and riparian plant seedlings or seeds are added to each planter. A fish channel is formed, either between twin rows of planters and reservoirs, or between a row of planters and reservoirs and a stormwater channel wall. Optionally, fish blocks are secured intermittently within the fish channel. A pumping system is provided to withdraw water from the reservoirs.

Example 1. A stretch of mostly uncapped (open) stormwater channels extends approximately 37 miles from Baldwin Lake, in Arcadia, Calif., to the Pacific Ocean (Long Beach, Calif.) via the Arcadia Wash, Peck Lake, Rio Hondo Channel, and the Los Angeles River. The channels are modified by installing twin rows of multiple riparian planters alternating with multiple reservoirs along the floor of the stormwater channels. Each row contains planters alternating with reservoirs, but the rows are interrupted at some locations, such as where the channels change direction, where side channels intersect with a main channel, and at places where the path to the sea is unlined, such as at Peck Lake and Whitter Narrows Recreation Area. The twin rows are separated from each other by a fish channel approximately 12″-14″ wide. Each planter is 24″ wide, 12-14″ high“, and 1400′ long. Each reservoir is 24″×12-14”×1400′. (Note: a row containing two 1400′ long planters alternating with two 1400′ long reservoirs is 5,600′ long; slightly more than a mile. A row containing three 1400′ long planters alternating with three 1400′ long reservoirs is 8400′ long; about 1.6 miles. Even longer strings of planters and reservoirs can be used in stormwater channels that run for several miles.) Each 1400′ long reservoir has a water capacity of just less than 21,000 gallons.

The planters and reservoirs are formed in place by pouring concrete into wooden forms set up in the stormwater channel and allowing it to set. Filter media (polymer filters or membranes) are secured between adjacent planters and reservoirs. Small fish blocks are secured along the route (extending from either or both interior walls of the fish channel), approximately every 100′. Wherever a planter has an exposed free end, such as at the beginning of the course, and wherever the rows of alternating planters and reservoirs are interrupted, a metal grate or similar, partially open barrier, is installed at the upstream end of the exposed planter. Each planter is filled with the following five materials (percentages are by volume; the materials are placed or poured into the planters as beds): 5% river gravel (<½″ dia.), 10% biochar (≥¾ mm), 75% sand (≤⅛″ dia.), and 10% river rock (≥1¾″ dia.), and the tops of the planters are capped with removable steel grating (¼″ thick, 1½″ openings). The planters are planted with one or more plants native to Los Angeles county riparian ecosystems. Nonlimiting examples include various sedges, reeds, willows, etc. More specific examples include hair grass, watercress, cattails, pink agapanthus, pennywort, and primrose creeper. A pumping system is installed to permit water to be withdrawn from each reservoir during periods of high water flow (e.g., during winter and spring storms). The system includes a pump and associated piping coupled to each reservoir, a power supply, and a controller. Water removed from the reservoirs is pumped to one or more water treatment plants for subsequent use in nearby municipalities.

In another aspect of the invention, a method for relocating anadromous fish past a dam or other barrier in a stormwater channel or other waterway is provided. As migrating fish travel upstream through a stormwater channel, stream, or river, they may encounter a low dam or other barrier. Using a modified fish trap and a drone (unmanned aerial vehicle, “UAV”) it is possible to collect the fish as they pool up against the barrier; lift them out of the water; and carry them over and past the barrier, where they can be released to continue their upstream migration to spawn.

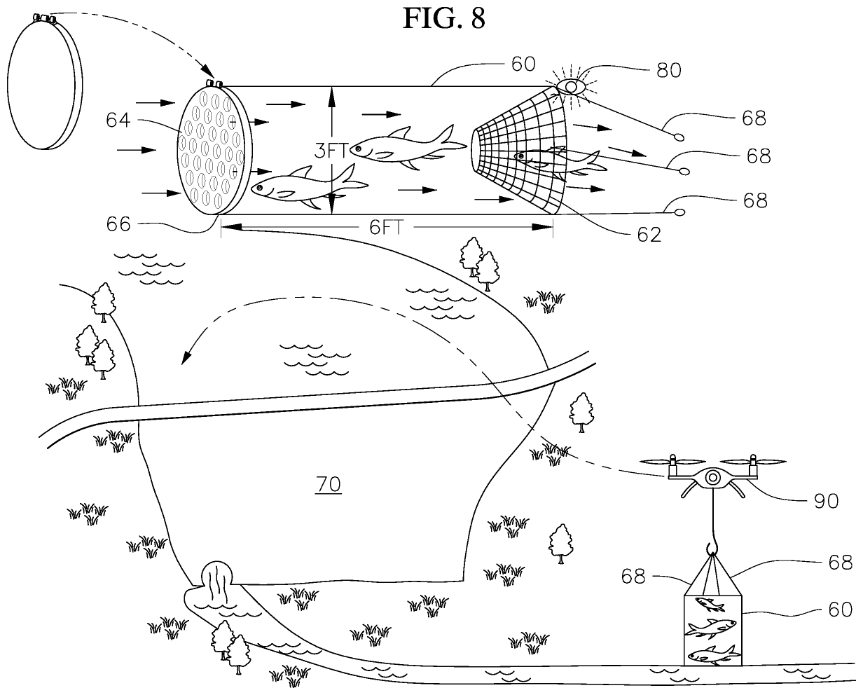

FIG. 8 illustrates one embodiment of a method for assisting steelhead, striped bass, sturgeon, and other anadromous fish in their migration. A lightweight, but strong, woven or mesh bottle trap 60 is secured underwater, adjacent to or in close proximity to the migration barrier; in this case, a low dam 70. The opening 62 of the trap is shaped like a funnel and extends into the interior of the trap. Fish can enter but cannot easily exit. At the opposite end, a door 64 is fastened shut, yet can be opened later by releasing a latch 66 or similar release mechanism. Leads 68 extend downstream from the trap.

As fish enter the trap, they are detected by an electronic counter 80 such as an optical sensor and controller placed near the trap. When enough fish have entered, the counter transmits a wireless signal to a receiver, such as the receiver in a mobile phone (not shown). Optionally, a small amount of a numbing agent, such as benzocaine hydrochloride, is released into the trap to calm the fish during transport. The operator of the phone then pilots a drone 90 having sufficient lifting capacity to pick up the fish and the trap and steers it to the trap, where a person on shore grabs the leads 68 of the trap and fastens them to the drone. The drone is then piloted over the barrier; the trap is opened; and the fish are released back into the waterway, upstream of the barrier, where they can continue their migratory journey.

While the invention has been described with reference to various embodiments and examples, other embodiments and modifications will be apparent to the skilled person after reading this disclosure. For example, some stormwater channels are formed with a cunette—a channel of small cross section formed in and extending longitudinally in the main bed of the channel, typically in the center, to concentrate flow at low-water stages. In one embodiment of the invention, the fish channel 40 is located above a cunette formed in the channel bed. (Either or both rows of alternating planters and reservoirs flank the cunette and the fish channel.) All such variations, embodiments, and modification fall within the scope of the present invention, which is limited only by the appended claims and equivalents thereof

What is claimed is:

1. A stormwater channel comprising:
a central channel bed flanked by a left wall or bank and a right wall or bank, and
a plurality of riparian planters and reservoirs secured to the channel bed and extending longitudinally in the channel, wherein each planter is in fluid communication with an adjacent reservoir and is loaded with riparian plant-anchoring material.

2. The stormwater channel of claim 1, wherein the plant-anchoring material comprises a mixture of gravel, sand, and rocks.

3. The stormwater channel of claim 1, wherein the plant-anchoring material comprises one or more beds of gravel, biochar, sand, and rocks.

4. The stormwater channel of claim 1, wherein each planter also contains biochar.

5. The stormwater channel of claim 4, wherein each planter contains a bed of gravel topped by a bed of biochar topped by a bed of sand, topped by a bed of rocks.

6. The stormwater channel of claim 1, wherein each planter is covered by grating.

7. The stormwater channel of claim 6, wherein the grating is removable.

8. The stormwater channel of claim 1, wherein each planter is rectangular in shape.

9. The stormwater channel of claim 1, wherein each reservoir is rectangular in shape.

10. The stormwater channel of claim 1, wherein each planter is adjacent to a reservoir.

11. The stormwater channel of claim 10, further comprising a water permeable filter between each planter and adjacent reservoir.

12. The stormwater channel of claim 1, wherein the plurality of riparian planters and reservoirs comprises two longitudinal rows of alternating planters and reservoirs, separated by a fish migration channel.

13. The stormwater channel of claim 12, further comprising a plurality of fish rest blocks extending laterally into the fish channel.

14. The stormwater channel of claim 1, wherein the planters and/or the reservoirs are made of concrete.

15. The stormwater channel of claim 1, further comprising a pumping system for removing water from some or all of the reservoirs.

16. The stormwater channel of claim 14, wherein the pumping system is solar-powered.

17. A method of modifying an existing stormwater channel to foster riparian plant growth, collect water for reuse, and facilitate upstream migration of anadromous fish, comprising:
forming a fish channel in the stormwater channel by building one or more rows of planters and alternating reservoirs in the stormwater channel;
filling each planter with riparian plant-anchoring material; and
adding riparian plant seedlings or seeds to each planter.

18. The method of claim 17, wherein each planter also contains biochar.

19. The method of claim 17, further comprising installing a pumping system for removing water from the reservoirs.

20. A method of collecting and transporting migrating fish over a barrier in a waterway, comprising:
detecting the fish as they approach the barrier;
trapping the fish in a trap;
lifting the trap with an unmanned aerial vehicle (drone);
transporting the fish in the trap over the barrier; and
releasing the fish into water upstream of the barrier.
